(19) United States
(12) Patent Application Publication
(10) Pub. No.: US 2018/0001664 A1
(43) Pub. Date: Jan. 4, 2018

(54) PREHEAT ZONES

(71) Applicant: HEWLETT-PACKARD DEVELOPMENT COMPANY, L.P., Houston, TX (US)

(72) Inventors: Pablo Vidal Alvarez, Barcelona (ES); Andreas Müeller, Barcelona (ES); Antonio Monclus Velasco, Barcelona (ES); Adria Olmos Marin, Barcelona (ES)

(73) Assignee: HEWLETT-PACKARD DEVELOPMENT COMPANY, L.P., Houston, TX (US)

(21) Appl. No.: 15/196,572

(22) Filed: Jun. 29, 2016

(51) Int. Cl. B41J 11/00

(52) U.S. Cl. CPC B41J 11/002

(57) ABSTRACT

In one example, a heat system includes a fluid movement device, a heater device, and a channel structure to direct fluid from the fluid movement device to a preheat zone.

### BACKGROUND

A printing device includes components to place print fluid on a print target. For example, a wide format printer may use water-based ink to print on a web print medium. Graphic prints, such as on wide format print mediums, printed using latex inks may use a drying process and a curing process to assist solidification of the ink.

### BRIEF DESCRIPTION OF THE DRAWINGS

FIG. 1 is a block diagram depicting an example heat system.

FIG. 2 depicts an example environment within a printing device in which various heat systems may be implemented.

FIG. 3 depicts example flow of fluid through an example heat system within an example environment.

FIG. 4 is a perspective view of an example heat system in an example environment.

FIG. 5 is an exploded view of an example diffuser.

FIG. 6 is a block diagram depicting an example heat system example monitor system.

### DETAILED DESCRIPTION

In the following description and figures, some example implementations of printing apparatus and heating systems are described. In examples described herein, a “printing device” may be a device to print content on a physical medium (e.g., paper or a layer of powder-based build material, etc.) with a print fluid (e.g., a fluid comprising ink or toner). For example, the printing device may be a wide-format printing device that prints latex-based print fluid on a print medium, such as a print medium that is size A2 or larger. In the case of printing on a layer of powder-based build material, the printing device may utilize the deposition of print fluids in a layer-wise additive manufacturing process. A printing device may utilize suitable printing consumables, such as ink, toner, fluids or powders, or other raw materials for printing. In some examples, a printing device may be a three-dimensional (3D) printing device. An example of print fluid is a water-based latex ink ejectable from a print head, such as a piezoelectric print head or a thermal inkjet print head. Other examples of print fluid may include dye-based color inks, pigment-based inks, solvents, gloss enhancers, and the like.

Some print fluids are water-based. A printing device may perform process including a drying stage and a curing stage when using water-based print fluid. For example, water-based fluid may be used in a printing device that includes a heat system to provide heat to the print fluid and a curing system to cure the print fluid. For example, heat may be expressed onto ink after ink is printed onto the medium to improve evaporation of the water within the ink and/or before the ink is cured by the curing system. Heat systems may generate volumes of heated fluid, such as hot air (e.g., air having a temperature above an external air temperature), to raise the temperature around the print medium to a temperature at which the print fluid may be dried and/or cured after placing print fluid in the medium. In this manner, the print medium may provide with heat to, after printing the print fluid, heat the print medium from an ambient temperature to the desired temperature for drying and/or curing.

Various examples described below relate to heating up the printing medium before print fluid is printed on a print medium. A heat system is described herein that provides heated fluid (e.g., heated air or other gas) to the print medium before the print zone. In this manner, the print medium may arrive at the print zone at a temperature above the ambient temperature and less heat may be used to bring the print medium to an appropriate drying or curing temperature after the print fluid is on the print medium, for example.

The terms “include,” “have,” and variations thereof, as used herein, mean the same as the term “comprise” or appropriate variation thereof. Furthermore, the term “based on,” as used herein, means “based at least in part on.” Thus, a feature that is described as based on some stimulus may be based only on the stimulus or a combination of stimuli including the stimulus.

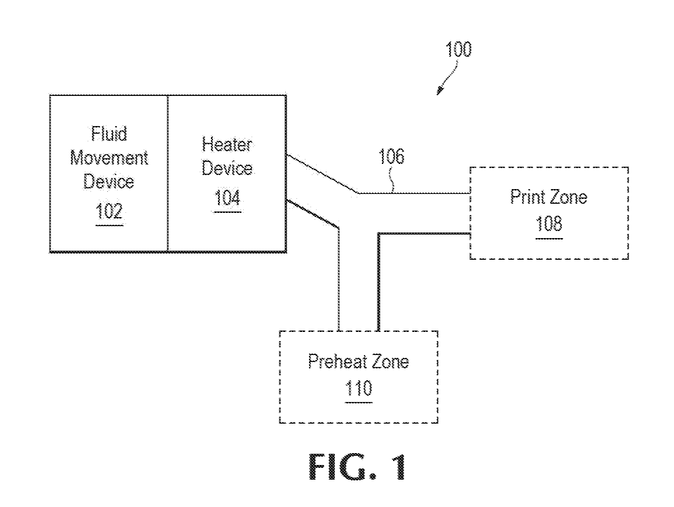

FIG. 1 is a block diagram depicting an example heat system 100. In general, the heat system 100 includes a fluid movement device 102, a heater device 104, and a channel structure 106. The heater device 104 heats fluid moved by the fluid movement device 102 and the channel structure 106 guides the heated fluid. The channel structure 106 may be defined with a plurality of outlets where a first outlet leads to a print zone 108 and a second outlet leads to a preheat zone 110 to preheat a print medium before entering the print zone 108. In this manner, the heat system 100 is able to direct fluid from the fluid movement device 102 to a print zone 108 and a preheat zone 110. In this manner, a heat fluid source (e.g., a fluid source comprising a combination of the fluid movement device 102 and the heater device 104) may drive or otherwise cause the heat system 100 to perform media preheating and print zone drying.

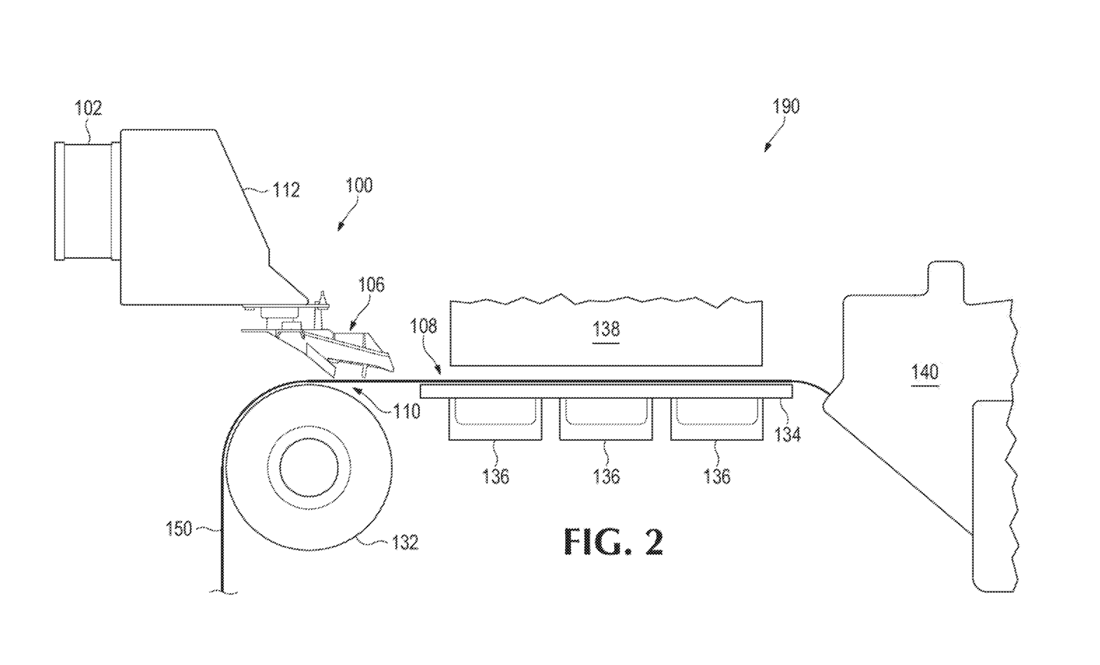

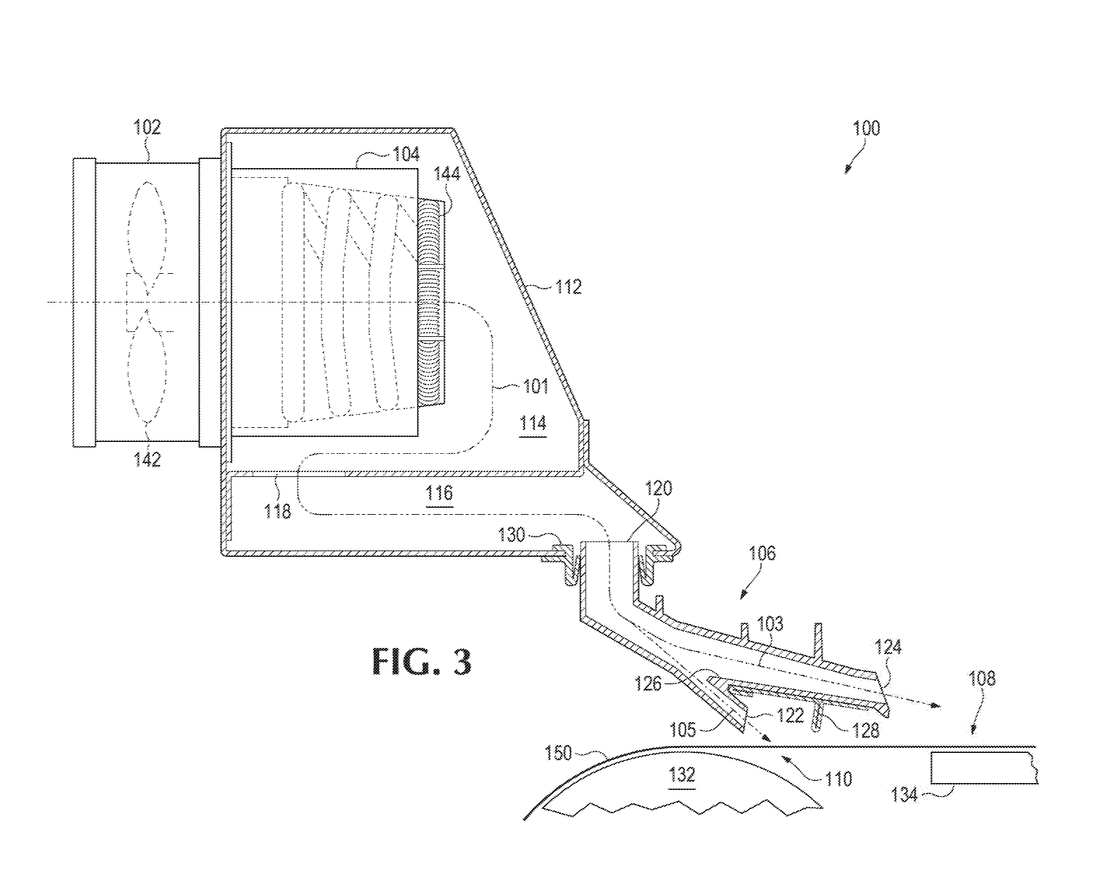

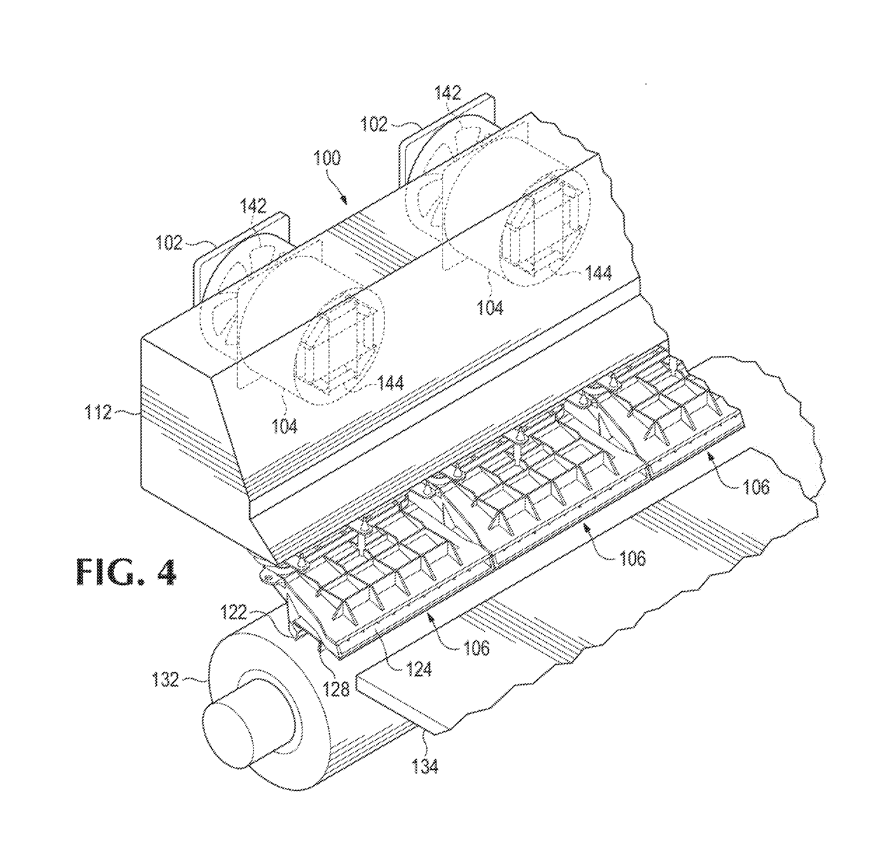

FIG. 2 depicts an example environment within a printing device 190 in which various heat systems 100 may be implemented. The heat system 100 of FIG. 2 includes components similar to the fluid movement device 102, the heater device 104 (not shown), and the channel structure, such as diffuser 106. As depicted in examples of FIGS. 3 and 4, the heater device 104 may be located in a support structure such as carriage beam 112. The heat system 100 may be oriented so that the outlets of diffuser 106 provide heated fluid (e.g., air) to the print zone 108 and a preheat zone 110 in front of the print zone 108. For example, the diffuser 106 may produce a substantially perpendicular air curtain (e.g., air knife) that preheats the media before the print zone 108 and a substantially parallel air curtain within the print zone 108 that transfers heat to evaporate water contained in the print fluid.

The media 150 arrives at the heating system 100 via a drive system 132. A drive system 132 may include a drive roller, a pinch roller, and/or other components to provide force on the media 150 to assist movement of the media 150. For example, the drive system 132 may include a pinch roller that holds the media against the driver roller which rotates to move the media 150 in the media advance direction towards the preheat zone 110 and the print zone 108. The preheat zone 110 in the example of FIG. 2 is located between the drive assembly 132 and the platen 134 (e.g., after a pinch mechanism directs media to the drive roller and before the print zone 110). The print zone 108 is located between the platen 134 and the print head assembly 138.

Vacuum devices 136 may be used to maintain the media 150 on the platen 134 during a print operation and/or other media handling operation. For example, a vacuum device 136 may retain the media 150 against the platen 134 after the media 150 is heated by heated fluid from the first outlet 122 of the diffuser 106 (e.g., channel structure) within the preheat zone 110 and retain the media 150 while the media 150 is heated by heated fluid from the second outlet 124 of the diffuser 106 within the print zone 108.

Once the media 150 is printed on, the media 150 exits the print zone 108 and enters a curing system 140 to cure latex-based inks, for example, printed onto the media 150. The curing system 150 may be aligned with the diffuser 106 to capture heated fluid that exits the print zone 108 after passing through the print zone 108 from the diffuser outlet 124 oriented towards the print zone 108.

FIG. 3 depicts example flow 101 of fluid through an example heat system 100 within an example printing environment. Fluid enters the fluid movement device 102 at a rate based on the movement of the fans 142 and moves through a heater device 104. The fluid is heated as the fluid moves through the heater device 104. For example, air may be pushed into a channel through the heater device with heater coals 144 wrapped around the interior of the channel (e.g., the heater coils 144 may form the channel). In this manner, the fluid movement device 102 may direct air heated by the header device 102 in a path through the chamber within structure 112.

As depicted in FIG. 3, the heater device 102 may be located within a chamber defined by a support structure 112, such as a carnage beam for the print head assembly with the chamber integrated into the print head carriage beam. For example, air entering the support structure 112 through inlets into the chamber may be heated as the air passes by the heater coils of the heater device 112.

The support structure 112 may define a plurality of sections of the chamber, such as sections 114 and 116. For example, air may enter the chamber through an inlet in the first section 114 and may exit the chamber through an outlet 13 in the second section 116 to the diffuser 106. The sections 114 and 116 may be arranged to cause uniformity of the flow of fluid across the diffuser 106. For example, the chamber may be a pressure chamber and the fluid may enter through the first chamber section 114, pass through a pathway 118 arranged between the first chamber section 114 and the second chamber section 116 to generate a pressure drop to cause airflow uniformity as the air passes through, and pass through an exit 130 of the pressure chamber to an entrance 120 of the diffuser 106.

The diffuser 106 is coupled to the support structure 112 so that the inlet 120 of the diffuser 106 interfaces with the exit 130 of the chamber section 116 to receive heated fluid from the chamber with in the support structure 112. The diffuser 106 may have a number of inlets that is less than a number of outlets. As depicted in FIG. 3, the diffuser 106 includes an inlet 120, a first outlet 122 oriented toward the preheat zone 110, and a second outlet 124 oriented toward the print zone 108. The outlet 122 of the diffuser 106 may be located adjacent to the drive system 132 and oriented to direct heated fluid out of the diffuser 106 to heat the media 150 before entering the print zone 108 with fluid heated by the heater device 102 and the outlet 124 of the diffuser 106 may be located adjacent to the platen 134 and oriented to direct heated fluid out of the diffuser 106 to heat the media 150 while in the print zone 108 with fluid heated by the heater device 102.

The structure of the channels of the diffuser 106 may include a division member 126 to split fluid flow 101 into fluid flows 103 and 105. In the example of FIG. 3, the fluid flow 103 flows through the outlet 124 that directs the fluid flow 103 substantially parallel to a media advance direction at the print zone 108 and the fluid flow 105 flows through the outlet 122 that directs the fluid flow 105 substantially towards the media 150 between the drive system 132 and the platen 134. The outlet 122 may be oriented in an oblique direction with respect to the media advance direction to direct flow 105 towards the media before entering the print zone 108. In another example, the outlet 122 may be oriented in a substantially perpendicular direction with respect to the media advance direction. The outlets 122 and 124 may, in this manner, direct heated fluid at different angles and/or otherwise direct heat fluid at different locations within the printing device 190.

The structure of the diffuser 106 may be designed to generate different amounts of fluid flow. For example, the outlet 124 may have a structure design of a channel that is larger than the outlet 122 so that the airflow 103 is greater than the airflow 105. For another example, the division member 126 may be oriented towards the fluid flow 101 so that the division member 126 directs a first amount of air to the outlet 122 that is less than a second amount of air directed to the outlet 124. For yet, another example, the diffuser 106 may be structured so that division member 126 assists about twice of the amount of heated fluid to be guided to the outlet 124 to the print zone as the amount of heated fluid to the outlet 122 to the preheat zone.

A deflector 128 (such as a wall or other barrier) may be coupled to the diffuser 106 between the outlet 122 and the outlet 124 to hinder the fluid flow 105 from combining with the fluid flow 103. The deflector 128 may be oriented to retain the fluid flow 105 in the preheat zone 110 and/or otherwise block fluid flow 105 from the outlet 122 from entering the print zone 108.

FIG. 4 is a perspective view of an example heat system 100 in an example environment of a wide format printing device. In the example of FIG. 4, the heat system 100 may comprise a plurality of fluid movement devices 102, a plurality of heater devices 104, and a plurality of diffusers 106. The number of components may have a corresponding number of complementary components of the heat system 100. For example, there may be a number of fluid movement devices 102 and a heater device 104 may be paired with each of the fluid movement devices 102 so that each coil heater 144 is attached a chamber entrance associated with one of the axial fans 142. The fluid heated and moved by the heat system 100 may be fluid within a housing of the printing device or fluid external to the housing of the printing device. For example, the airflow source for the heat system 100 may include an array of axial fans 142 coupled to the support structure 112 to bring air into the pressure chamber and an array of coil heaters 144 may heat the air brought into the pressure chamber. The components may he adjustable to allow for the various combinations of fluid flow rates and temperatures to be used in accordance with the combinations of types of media, types of print fluid, and print settings (e.g., print modes). For example, each of the axial fans 142 of the fluid movement devices 102 may have an adjustable fan speed and each coil heaters 144 of the heater devices 104 may have an adjustable temperature. The components may be individually adjustable.

The plurality of diffusers 106 may be coupled to the pressure chamber within the support structure 112. The support structure 112 enclosing the pressure chamber may be about the width of the print zone of the printing device. The plurality of diffusers 106 may include an outlet 124 oriented to direct heated fluid towards a print zone and an outlet 122 oriented to direct heated fluid towards the preheat zone in front of the print zone (with reference to the media advance direction.) In other examples, each diffuser 106 may have multiple outlets 122 oriented towards the preheat zone and/or multiple outlets 124 oriented towards the print zone. The pressure chamber may lead fluid to the preheat zone outlet 122 via the diffuser 106 to direct fluid flow in a direction towards the print surface of the media in the preheat zone to heat the media before entering the print zone. The pressure chamber may lead fluid to the print zone outlet 124 via the diffuser 106 to direct fluid flow in a substantially parallel direction to the media advance direction of media within the print zone. By providing multiple outlets from each diffuser 106, preheating a section of media at the preheat zone and drying the section of media in the print zone may be driven by a single fluid heating source (e.g., a fan and heater combination concurrently provides heated air used for both preheating and print zone drying of a particular lane of media passing through the print system). In the example of FIG. 4, each axial fan and heater combination provides heated fluid to multiple diffusers 106 (e.g., there are less heated fluid sources than diffusers and, therefore, less heated fluid sources than outlets to the media path).

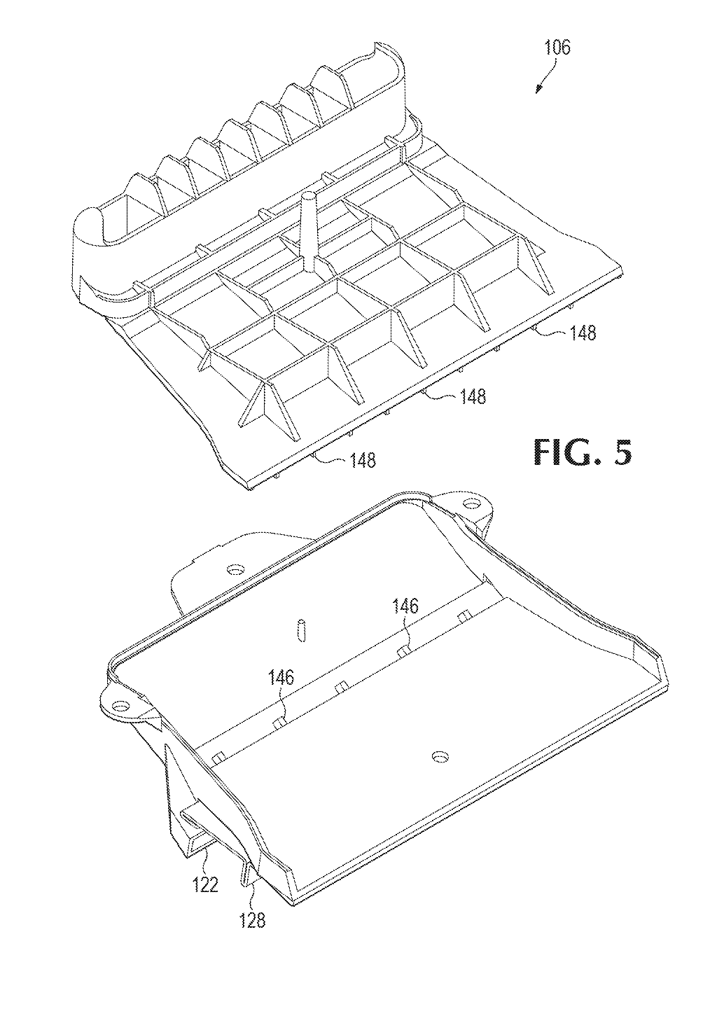

FIG. 5 is an exploded view of an example diffuser 106. The example diffuser 106 may be composed of multiple structural components. Other example diffusers 106 may be integrated as a single structural component. In the example of FIG. 5, the structural components of the diffuser 106 attach to create outlet 124 and the bottom structural component is structured to have an outlet 122 so that a portion of the fluid that flows through the diffuser exits the outlet 122 before the print zone (e.g., into the preheat zone) rather than exit through the outlet 124 to the print zone.

The diffuser 160 may include ribs 146 in the outlet 122 to generate substantially uniform fluid flow at the outlet 122. The diffuser 106 may include ribs 148 in the outlet 124 of diffuser 106 to generate substantially uniform fluid flow at the outlet 124.

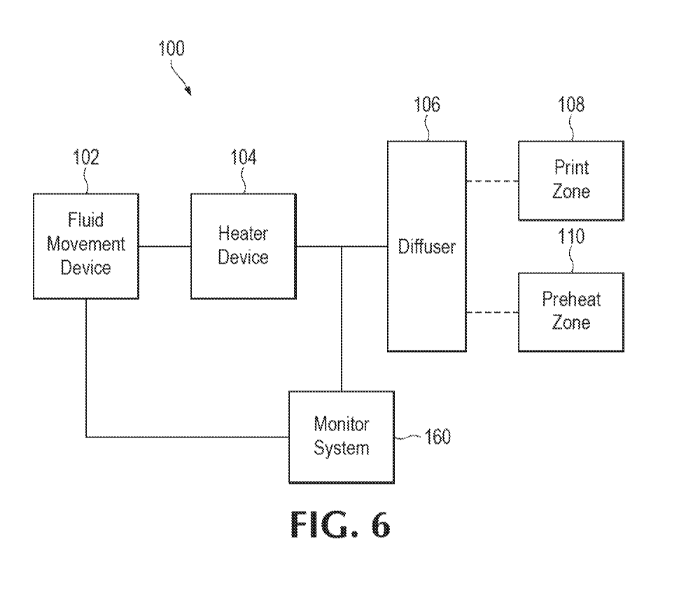

FIG. 6 is a block diagram depicting an example heat system 100 with an example monitor system 160. The monitor system 160 is circuitry or a combination of circuitry and executable instructions that when executed cause the circuitry to monitor uniformity of temperature and/or uniformity of fluid flow rate. For example, the monitor system 160 may include a sensor communicatively coupled to a processor resource that executes instructions stored on a memory resource to analyze the data from the sensor and cause the fluid movement device 102 to adjust based on changes to the flow rate (e.g., air speed) identifiable from the sensor data and/or target fluid flow threshold values. As discussed with respect to FIG. 3, the pressure chamber may include multiple sections to generate a substantial uniform pressure differential to lead fluid from the fluid movement device 102 (e.g., from a plurality of axial fans) to the diffuser 106. As discussed with respect to FIG. 5, substantially uniform fluid flow may he generated based on the structure of the diffuser 106, such as using ribs 146 and 148 or the placement of a plurality of diffusers 106. In both examples, an example monitor system 160 may utilize a dosed loop system based on sensor data retrieved within the chamber or otherwise between the heater device and the diffuser to identify adjustments in rate of intake of the fluid movement device 102 to adjust pressure drop differential and/or degree of uniformity of airflow through the diffusers 106. In another example, the monitor system 160 may utilize sensor data of a plurality of sensors within the support structure 112 to determine uniformity of temperature along the preheat zone and may, such as in a dosed loop system, adjust the temperature of the heater device 104 (e.g., adjust the temperature of heater coils) to adjust the temperature of the heated fluid guided to the preheat zone and/or bring a section of the airflow into substantial temperature uniformity with another section of the airflow.

As mentioned above, the monitor system 106 may include a combination of circuitry and executable instructions, such as a processor resource and executable instructions stored on a memory resource. The processor resource may be any appropriate circuitry capable of processing (e.g., computing) instructions, such as one or multiple processing elements capable of retrieving instructions from the memory resource and executing those instructions. For example, the processor resource may be a central processing unit (CPU) that enables monitor and adjustment of temperature and/or fluid flow by fetching, decoding, and executing instructions stored on a memory resource. Example processor resources include at least one CPU, a semiconductor-based microprocessor, a programmable logic device (PLD), and the like. Example PLDs include an application specific integrated circuit (ASIC), a field-programmable gate array (FPGA), a programmable array logic (PAL), a complex programmable logic device (CPLD), and an erasable programmable logic device (EPLD). The processor resource may include multiple processing elements that are integrated in a single device or distributed across devices. The processor resource may process the instructions serially, concurrently, or in partial concurrence.

A memory resource may be any appropriate non-transitory medium or combination of non-transitory media able to electronically store data utilized and/or produced by the system 160. For example, the medium may be a machine-readable storage medium, which is distinct from a transitory transmission medium, such as a signal. The medium may be an electronic, magnetic, optical, or other physical storage device that is capable of containing (i.e., storing) executable instructions. The memory resource may be a non-volatile memory resource such as read only memory (ROM), a volatile memory resource such as random access memory (RAM), a storage device, or a combination thereof. Example forms of a memory resource include static RAM (SRAM), dynamic RAM (DRAM), electrically erasable programmable ROM (EEPROM), flash memory, or the like. The memory resource may include integrated memory such as a hard drive (HD), a solid state drive (SSD), or an optical drive. The memory resource may be integrated in the same device as the processor resource, separate but accessible to that device and the processor resource, or distributed across devices. The memory resource may be said to store program instructions that when executed by the processor resource cause the processor resource to implement functionality of the system 160.

All of the features disclosed in this specification (including any accompanying claims, abstract and drawings), and/or all of the elements of any method or process so disclosed, may be combined in any combination, except combinations where at least some of such features and/or elements are mutually exclusive.

The present description has been shown and described with reference to the foregoing examples. It is understood, however, that other forms, details, and examples may be made without departing from the spirit and scope of the following claims. The use of the words “first,” “second,” or related terms in the claims are not used to limit the claim elements to an order or location, but are merely used to distinguish separate claim elements.

1.-4. (canceled)

5. A printing device, comprising:
a chamber having an exit;
a heater device to heat air;
a fluid movement device to direct air heated by the heater device in the chamber; and
a diffuser coupled to the exit of the chamber, the diffuser comprising:
an inlet to receive heated air heated by the heater device from the chamber;
a first outlet formed by a first wall oriented to guide a first portion of the heated air from the inlet toward a preheat zone, with respect to a media advance direction, to heat media before entering a print zone with the first portion of the heated air heated by the heater device;
a second outlet formed by a second wall oriented to guide a second portion of the heated air from the inlet toward the print zone, with respect to the media advance direction, to heat the media while in the print zone with the second portion of the heated air heated by the heater device; and
a division member that divides the inlet into the first outlet and the second outlet.

6. The printing device of claim 5, wherein:
the diffuser is to direct a first amount of air to the first outlet that is less than a second amount of air directed to the second outlet.

7. The printing device of claim 5, wherein:
the chamber is a pressure chamber having a first section and a second section arranged to generate a pressure drop to cause airflow uniformity across the diffuser; and
ribs in the diffuser generate substantially uniform airflow at each of the first outlet and the second outlet.

8. The printing device of claim 7, wherein:
the chamber is integrated into a beam that supports a print head assembly such that the print head assembly moves over the print zone.

9. The printing device of claim 5, further comprising:
a curing module coupled to the diffuser to capture air from the second outlet.

10. The printing device of claim 5, further comprising:
a vacuum device to:
retain media after the media is heated by air from the first outlet; and
retain the media while the media is heated by air from the second outlet within the print zone.

11. The printing device of claim 5, further comprising:
a deflector coupled to the diffuser to block airflow from the first outlet from entering the print zone.

12.-16. (canceled)

17. The printing device of claim 5, wherein the heater device comprises coil heaters.

18. The printing device of claim 5, further comprising a monitor system to monitor uniformity of temperature and uniformity of flow rate.

19. The printing device of claim 5, further comprising:
a media support member to support the media to be printed on in the print zone; and
a support structure comprising the chamber, wherein the heater device is in the support structure, and the fluid movement device is attached to the support structure, and
wherein the support structure, the heater device, and the fluid movement device are arranged above the media support member.
